(19) United States
(12) Patent Application Publication
(10) Pub. No.: US 2012/0155949 A1
(43) Pub. Date: Jun. 21, 2012

(54) Joint Instrument Support Assembly

(75) Inventor: Ming-Yi Chang, Taichung City (TW)

(73) Assignee: REMARKABLE COMPANY, Taichung City (TW)

(21) Appl. No.: 13/407,177

(22) Filed: Feb. 28, 2012

Related U.S. Application Data
(63) Continuation-in-part of application No. 12/549,481, filed on Aug. 28, 2009.

(51) Int. Cl. F16D 1/12

(52) U.S. Cl. 403/84

(57) ABSTRACT

A joint instrument support assembly has a rotating elbow with two ear parts. A groove is formed between the two ear parts. One ear part communicates with the groove via a circular hole. Each ear part has a circular wall facing toward the groove. A rotating block is disposed in the rotating elbow. A rod goes through the rotating block. A limiting element locks on the rod and positions in the axle hole to rotate with respect to the rotating block. A sliding block with a through hole and an outer thread part is disposed in an accommodating room. A pad is mounted on the outer thread part and strides across the outer edges of the two circular walls. A fastening element locks onto the outer thread part outside the pad.

### CROSS-REFERENCE TO RELATED APPLICATION

This application is a Continuation-In-Part application of Ser. No. 12/549,481, filed on Aug. 28, 2009, and entitled “JOINT INSTRUMENT SUPPORT ASSEMBLY”, now pending.

### BACKGROUND OF THE INVENTION

1. Field of Invention

The invention relates to a joint instrument support assembly and, in particular, to a structure that is disposed on the base of an instrument support and connects to the instrument.

2. Related Art

As shown in FIG. 9, a conventional instrument support assembly has a rotating elbow 80 connecting a cymbal 81 to the support frame 82 for adjusting the orientation thereof. The rotating elbow 80 has an elbow base 801 fixed to the rod 82 of the support frame. A rotating block 802 connects to the cymbal 81. The elbow base 801 and the rotating block 802 engage with each other by teeth. When they are released, one can adjust the angle between the cymbal 81 and the support frame. When they are fastened, the angle is fixed.

However, in the above-mentioned instrument support assembly, to adjust the angle of the rotating elbow 80 relative to the elbow base 801, one has to engage the teeth of the rotating block 802 and the elbow base 801 in order to fix it. The engaging positions of the teeth have a fixed span. Therefore, one cannot arbitrarily change the angle and fix it. This is a restriction. Besides, the elbow base 801 is fixed on the rod 82 of the support frame. Thus, to adjust the cymbal 81 horizontally, one has to release the rod 82 on the support frame and rotate the rod 82 for the cymbal 81 to rotate to the left or right. Therefore, rotating the cymbal 81 with respect to a vertical axis and a horizontal axis have to be done separately. This usually involves several adjustments back and forth in order to find a best orientation. It is very time-consuming.

FIG. 10 shows another conventional instrument support assembly, used to join a bass drum and a side drum in a drum set. The bass drum connects to a rotating elbow 91 and then to the side drum via a base 90. As shown in the drawing, to adjust the position of the side drum, one has to release the base 90 in order to rotate with respect to a vertical axis. One has to release the rotating elbow 91 in order to rotate the side drum with respect to a horizontal axis. So the adjustments still have to be done several times separately. It is still quite inconvenient.

Consequently, both of the above-mentioned two conventional instrument support assemblies have the problem of inconvenient in adjustments. It is thus an objective of the invention to solve this problem.

### SUMMARY OF THE INVENTION

In view of the foregoing, the invention provides a joint instrument support assembly to make the orientation adjustment of an instrument on the support frame more quickly.

The disclosed joint instrument support assembly includes: a rotating elbow, a cylindrical rotating block, a sliding block, a pad, and a fastening element.

The rotating elbow with a first side having a first ear part and a second side having a second ear part, and a groove formed between the first ear part and the second ear part, the first ear part having a circular hole to communicate with the groove and each ear part having a circular wall facing toward the groove, each circular wall being integral part of the rotating elbow and having a notch that makes each circular wall an open ring and an outer diameter that is greater than a diameter of the circular hole.

The cylindrical rotating block that passes through the circular hole of the first ear part, urges against the second ear part, and rotates within the two circular walls; the cylindrical rotating block goes through an accommodating room, with a first end and a second end, and an axle hole in a radial direction, a rod, having a first end with a connecting device for connecting to an instrument or a support frame and a second end with a screw hole and a plurality of first teeth on the outer annular surface of its second end that is inserted into a through hole of the sliding block, with the first teeth further extending along the axial direction of the rod and each of the first teeth consisting of a tooth trough, a tooth crest, and a tooth surface, goes via the axle hole into the cylindrical rotating block, and the rod goes through the accommodating room to connect to the cylindrical rotating block.

The sliding block, which is disposed in the accommodating room, has a through hole corresponding to the axle hole for the second end of rod to go through, the inner surrounding of the through hole having a plurality of second teeth formed on the annular surface and the second teeth extending along the axial direction of the through hole, with each of the second teeth consists of a tooth crest, a tooth trough, and a tooth surface in such a way that the diameter of the tooth crests of the second teeth is larger than the diameter of the tooth crests of the first teeth, and is protruded with an outer thread part toward the cylindrical rotating block, the sliding block being capable of passing through the notch on each circular wall.

The pad with a first end and a second end, which is mounted on the outer thread part with the first end and the second end striding between two circular walls.

The fastening element, which locks onto the outer thread part outside the pad and guides the sliding block to move within the accommodating room so that the second teeth urges tightly against the first teeth in the radial direction of the rod and the tooth surface of the second teeth is blocked by the tooth surface of the first teeth to prevent the sliding block from tilting on the rod as the fastening element rotates, thereby urging the rod to the cylindrical rotating block, wherein the axle hole goes from the cylindrical rotating block through one sidewall of the accommodating room, an opposite sidewall of the accommodating room has a recess, a connecting hole goes through the recess, the rod goes through the accommodating room and into the recess, the rod urges against the recess, a limiting member has an outer thread part and a head part, with the outer thread part going through the connecting hole and locking into the screw hole, a gap L is formed between the head part and the end surface of the rod, with the gap L being wider than the depth of the connecting hole, and the rod is secured to the cylindrical rotating block with the limiting member inserted into the screw hole.

The sliding block having a width that is larger than a distance between two circular walls, and a distance between the inlet and two notches is larger than the width of the sliding block.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the first embodiment in use;

FIG. 2 is a three-dimensional perspective view of the first embodiment;

FIG. 3 is a three-dimensional exploded view of the first embodiment;

FIG. 4a is a cross-sectional view of the connected rod in the first embodiment;

FIG. 4b is an enlarged portion of FIG. 4a;

FIG. 5 is a cross-sectional view of the released rod in the first embodiment;

FIG. 6 shows the rotation with respect to a vertical axis in the first embodiment;

FIG. 7 shows the rotation with respect to a horizontal axis in the first embodiment;

FIG. 8a is a cross-sectional view of the urging rod in the first embodiment;

FIG. 8b is an enlarged portion of FIG. 8a.

FIG. 9 is an exploded view of the components in a conventional instrument support assembly; and

FIG. 10 is a three-dimensional view of another conventional instrument support assembly.

### DETAILED DESCRIPTION OF THE INVENTION

The present invention will be apparent from the following detailed description, which proceeds with reference to the accompanying drawings, wherein the same references relate to the same elements.

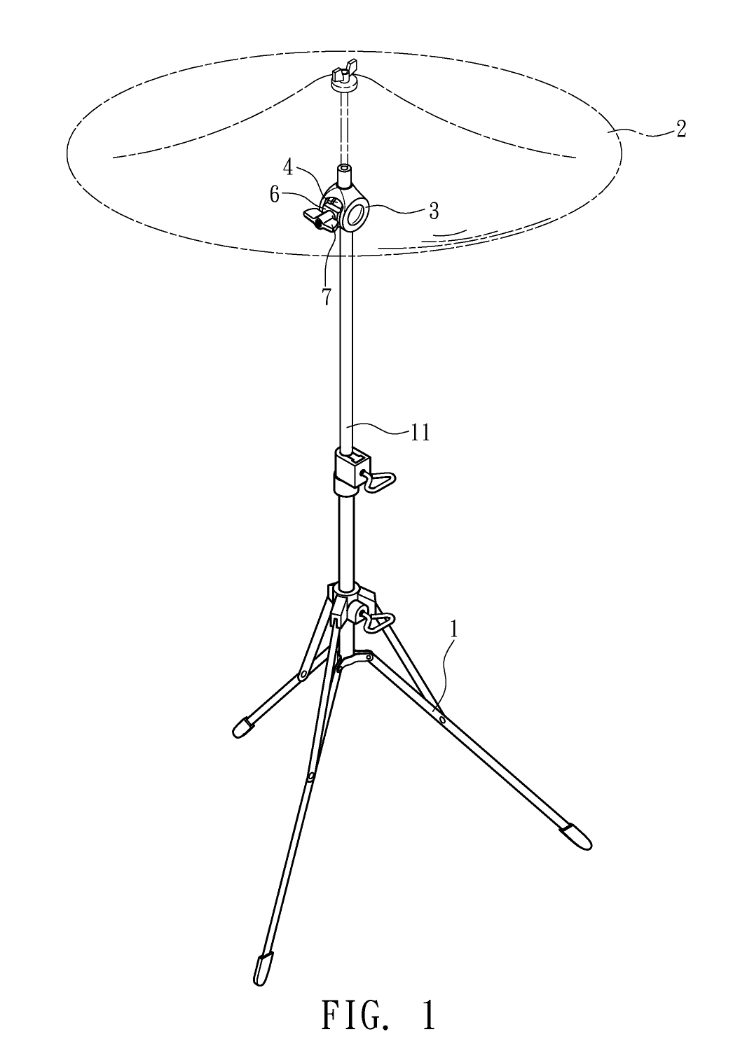

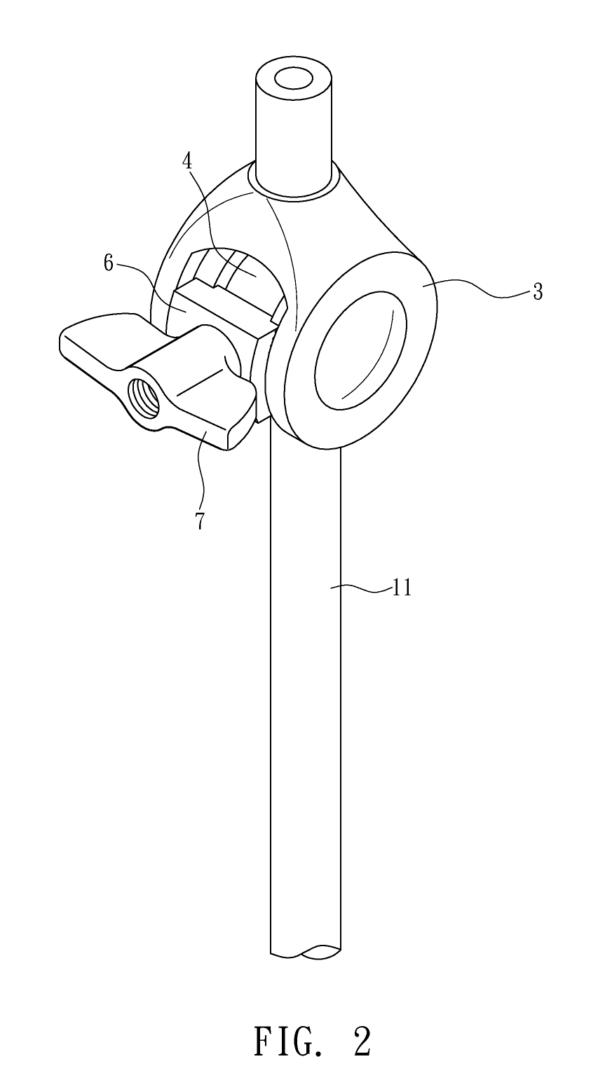

Please refer to FIGS. 1 to 5 for a first embodiment of the invention. This is only an illustration and should not be used to restrict the scope of the invention.

This embodiment provides a joint instrument support assembly for a vertical support frame 1 to fix and adjust a cymbal 2. It includes: a rotating elbow 3, a cylindrical rotating block 4, a sliding block 5, a pad 6, and a fastening element 7.

The rotating elbow 3 with a first side having a first ear part 31 and a second side having a second ear part 32. A groove 33 formed between the first ear parts 31 and second ear part 32. The ear part 31 having a circular hole 34 to communicate with the groove 33, each ear parts 31, 32 having a circular wall 35 facing toward the groove, each circular wall 35 being integral part of the rotating elbow 3 and having a notch 350 that makes each circular wall 35 an open ring, and an outer diameter that is greater than a diameter of the circular hole 34.

The cylindrical rotating block 4 that passes through the circular hole 34 of the first ear part 31, urges against the second ear part 32. It is restricted to rotate within the two circular walls 35. The rotating block 4 goes through an accommodating room 41, with a first end and a second end, and an axle hole 42 in a radial direction. A rod 11 has a first end with a connecting device for connecting to an instrument or a support frame and a second end with a screw hole 111 and a plurality of first teeth 113 on the outer annular surface 112 of its second end that is inserted into a through hole 51 of the sliding block 5. The first teeth 113 further extend along the axial direction of the rod 11. Each of the first teeth 113 consists of a tooth trough, a tooth crest, and a tooth surface. The rod 11 goes via the axle hole 42 into the cylindrical rotating block 4. The rod 11 goes through the accommodating room 41 and connects to the cylindrical rotating block 4, and the rod 11 can rotate with respect to the cylindrical rotating block 4.

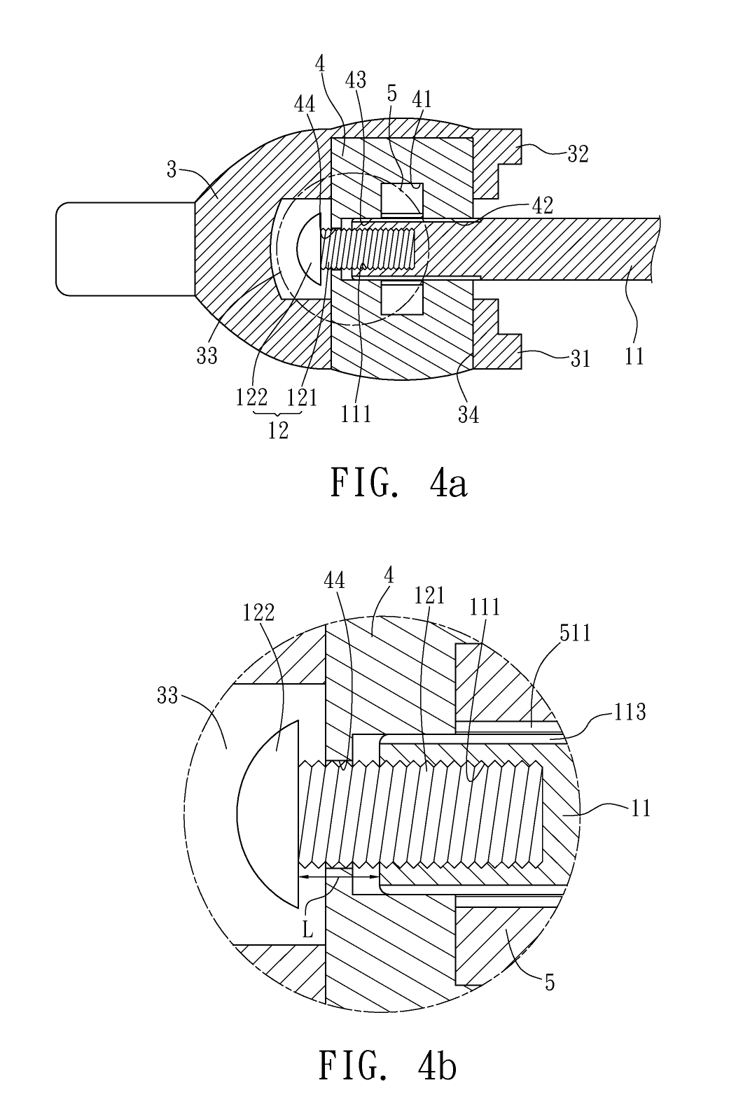

On the axle hole 42 goes from the cylindrical rotating block 4 through one sidewall of the accommodating room 41, an opposite sidewall of the accommodating room 41 has a recess 43, a connecting hole 44 goes through the recess 43. The rod 11 goes through the accommodating room 41 and into the recess 43, the rod 11 urges against the recess 43. A limiting member 12 has an outer thread part 121 and a head part 122. The outer thread part 121 of the limiting member 12 goes through the connecting hole 44 and locks into the screw hole 111. There is a gap L between the head part 122 and the end surface of the rod 11 (as shown in FIG. 4b). The gap L is wider than the depth of the connecting hole 44. The rod 11 is secured to the cylindrical rotating block 4 with the limiting member 12 inserted into the screw hole 111.

The sliding block 5 is disposed in the accommodating room 41. The sliding block 5 has a through hole 51 corresponding to the axle hole 42 for the rod 11 to go through. The inner surrounding of the through hole 51 of the sliding block 5 has a plurality of second teeth 511 formed on the annular surface. The second teeth 511 extend along the axial direction of the through hole 51. Each of the second teeth 511 consists of a tooth crest, a tooth trough, and a tooth surface. The diameter of the tooth crests of the second teeth 511 is larger than the diameter of the tooth crests of the first teeth 113. Being protruded with an outer thread part 52 toward the cylindrical rotating block 4, the sliding block 5 is capable of passing through the notch 350 on each circular wall 35.

The pad 6 with a first end and a second end, which is mounted on the outer thread part 52 with the first end and the second end striding between two circular walls 35.

The fastening element 7 locks onto the outer thread part 52 outside the pad 6 and guides the sliding block 5 to move within the accommodating room 41, so that the second teeth 511 urges tightly against the first teeth 113 in the radial direction of the rod 11 and the tooth surface of the second teeth 511 is blocked by the tooth surface of the first teeth 113 to prevent the sliding block 5 from tilting on the rod 11 as the fastening element 7 rotates, thereby urging the rod 11 to the cylindrical rotating block 4.

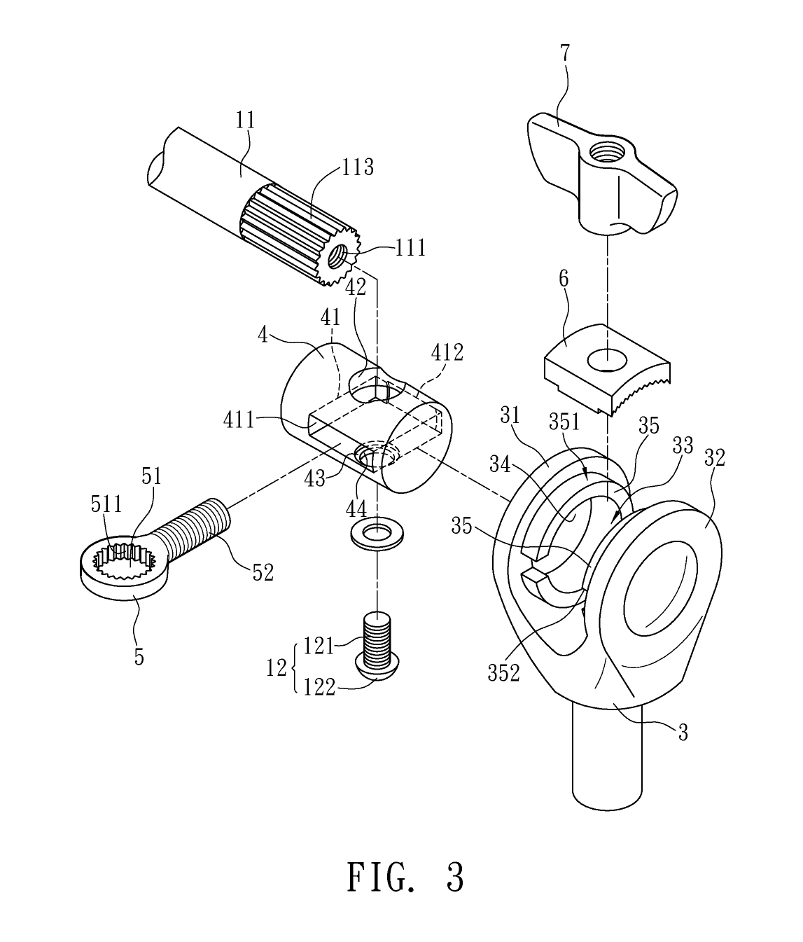

As shown in FIGS. 3 to 4a, the rotating block 4 has an inlet 411 on the first end of the accommodating room 41 and an outlet 412 on the second end of the accommodating room 41. The inlet 411 is larger than the width of the sliding block 5, so that the sliding block 5 can enter the accommodating room 41. The outlet 412 is smaller than the width of the sliding block 5 for the outer thread part 52 to extend out. On the rotating elbow 3 of the embodiment, each notch 350 is formed on the corresponding positions on each circular walls 35. As the rotating block 4 rotates through the two notches 350 can correspond to the inlet 411 of the accommodating room 41, the sliding block 5 can enter the accommodating room 41 of the cylindrical rotating block 4.

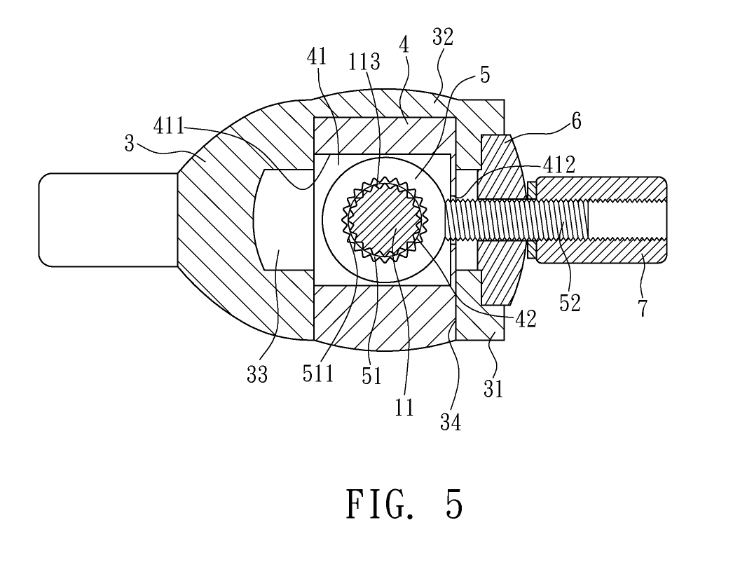

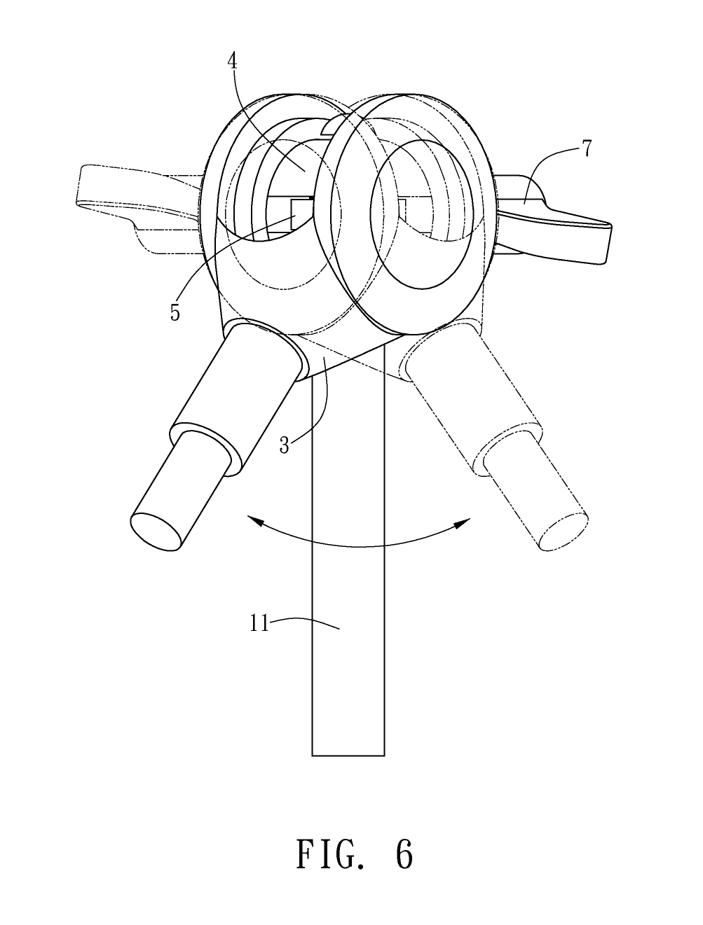

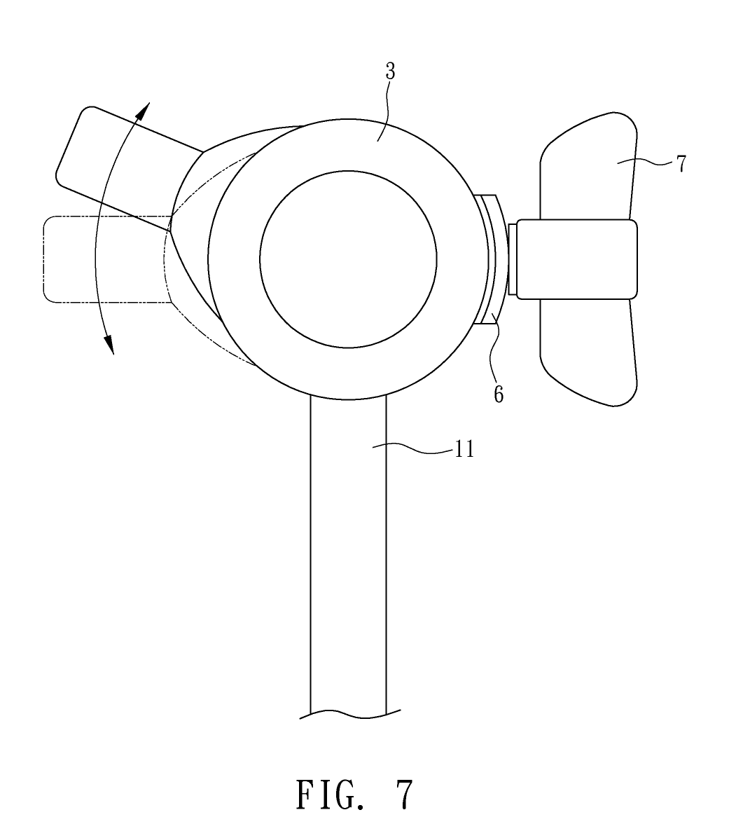

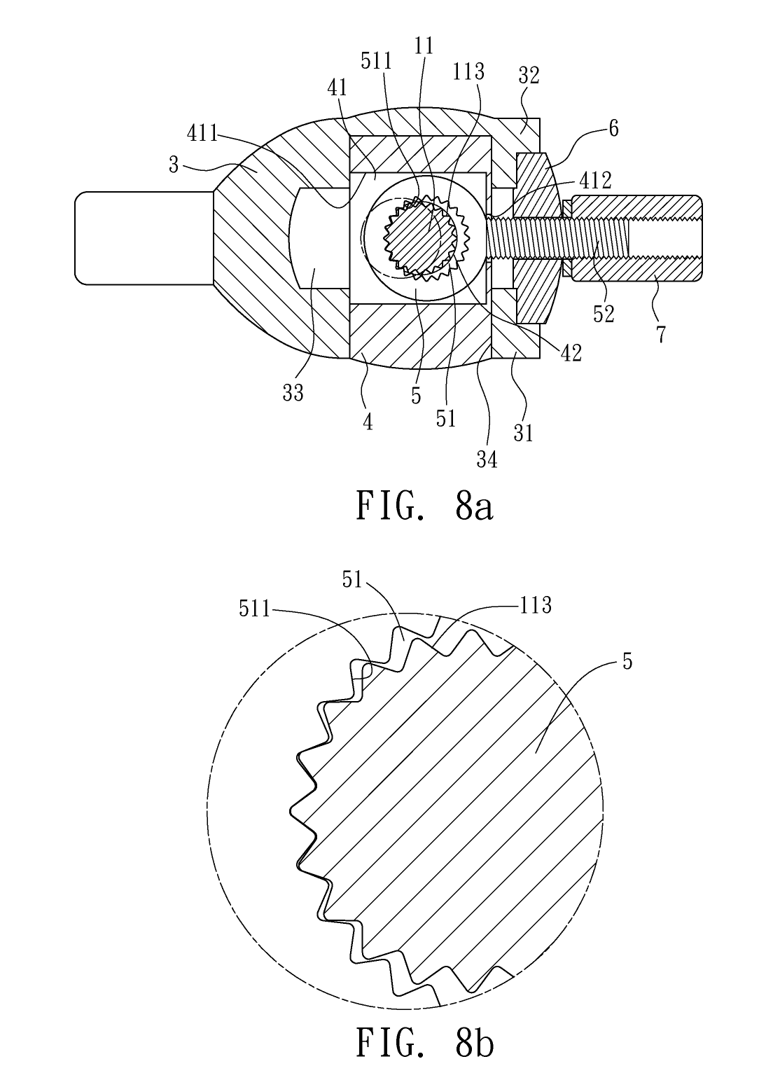

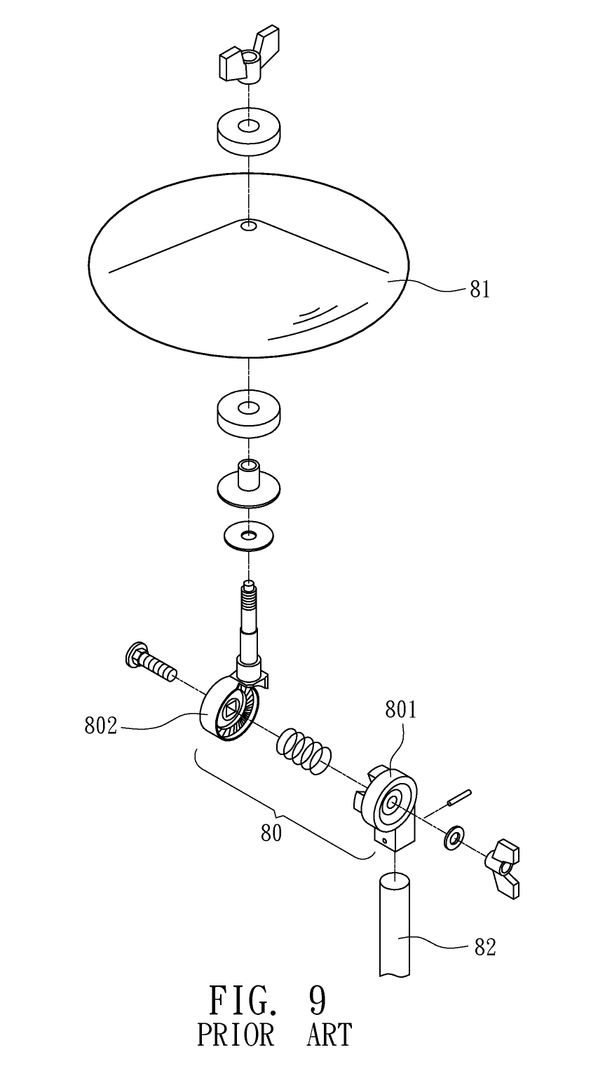

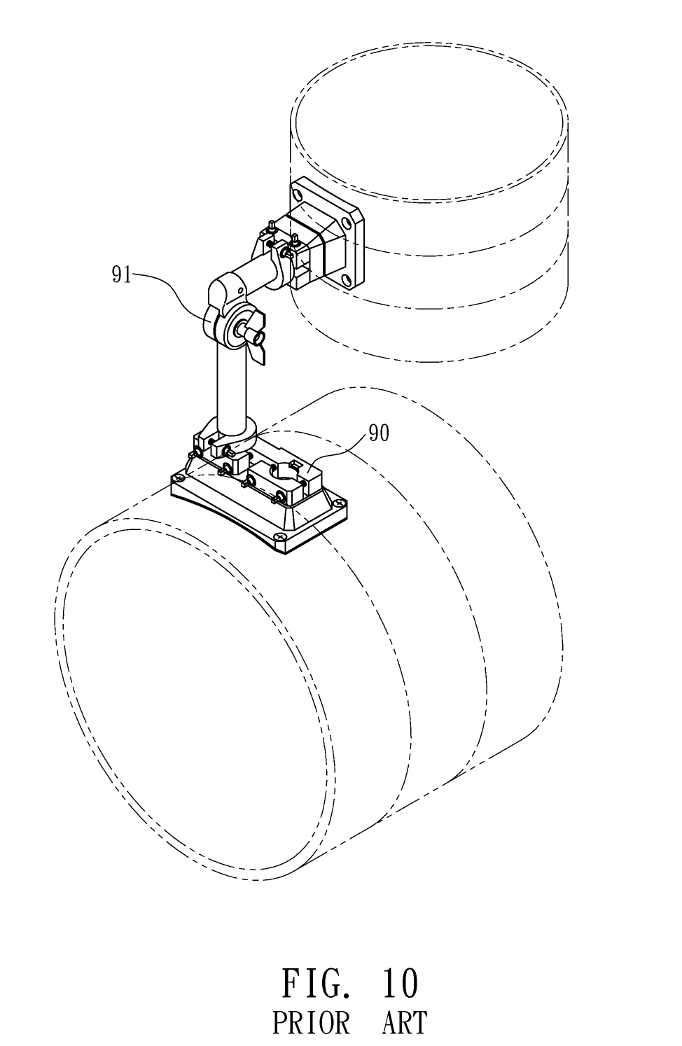

As shown in FIG. 5, when the fastening element 7 is relaxed, the sliding block 5 is loose in the rotating elbow 3. As shown in FIG. 6, the rotating elbow 3 can freely rotate on the rod 11. Since the rod 11 and the rotating block 4 are not fixed by the limiting member 12, the instrument or support frame connected to the rod 11 can be arbitrarily rotated on the second end of the rod 11. Moreover, the pad 6 and the rotating elbow 3 are relaxed. Therefore, the rotating elbow 3, as shown in FIG. 7, can freely swing up and downs relative to the rotating block 4. The rotating elbow 3 allows the simultaneous adjustments of the cymbal 2 in the vertical and horizontal directions of the rod 11 of the support frame 1. After the adjustments, one fastens the fastening element 7, as shown in FIGS. 8a to 8b. In this case, the sliding block 5 in the accommodating room 41 of the rotating block 4 is driven to urge the rod 11 against the rotating block 4. In particular, when the second teeth 511 of the sliding block 5 urge tightly against the tooth surface of the first teeth 113 of the rod 11, the rod is pinched between the second teeth 511 of the sliding block 5 and the inner wall of the axle hole 42. The tooth surface of the second teeth 113 is in contact with and blocked by the tooth surface of the first teeth 113. When the fastening element 7 rotates on the outer thread part 52, it can prevent the sliding block 5 from tilting on the rod 11 as the fastening element 7 rotates. It further ensures that the rod 11 is firmly positioned by the sliding block 51. The pad 6 is urged by the fastening element 7 against the edges 351 of the two circular walls 35. Therefore, the rotating elbow 3 is positioned in the horizontal and vertical directions relative to the rod 11.

In comparison with the conventional instrument support assembly, the disclosed rotating elbow 3 does not involve any tooth structure. Thus, the rotating elbow 3 does not have limitation in angle, rendering a better freedom. Moreover, the disclosed rotating elbow 3 allows the simultaneous adjustment of the cymbal 2 in the horizontal and vertical directions relative to the rod 11. Therefore, one does not need to adjust several times as in the prior art. This largely shortens the adjusting time, making the adjustment easy and fast.

What is claimed is:

1. A joint instrument support assembly, comprising:
a rotating elbow with a first side having a first ear part and a second side having a second ear part, and a groove formed between the first ear part and the second ear part, the first ear part having a circular hole to communicate with the groove and each ear part having a circular wall facing toward the groove, each circular wall being integral part of the rotating elbow and having a notch that makes each circular wall an open ring and an outer diameter that is greater than a diameter of the circular hole;
a cylindrical rotating block that passes through the circular hole of the first ear part, urges against the second ear part, and rotates within the two circular walls; the cylindrical rotating block goes through an accommodating room, with a first end and a second end, and an axle hole in a radial direction, a rod, having a first end with a connecting device for connecting to an instrument or a support frame and a second end with a screw hole and a plurality of first teeth on the outer annular surface of its second end that is inserted into a through hole of the sliding block, with the first teeth further extending along the axial direction of the rod and each of the first teeth consisting of a tooth trough, a tooth crest, and a tooth surface, goes via the axle hole into the cylindrical rotating block, and the rod goes through the accommodating room to connect to the cylindrical rotating block;
a sliding block, which is disposed in the accommodating room, has a through hole corresponding to the axle hole for the second end of rod to go through, the inner surrounding of the through hole having a plurality of second teeth formed on the annular surface and the second teeth extending along the axial direction of the through hole, with each of the second teeth consists of a tooth crest, a tooth trough, and a tooth surface in such a way that the diameter of the tooth crests of the second teeth is larger than the diameter of the tooth crests of the first teeth, and is protruded with an outer thread part toward the cylindrical rotating block, the sliding block being capable of passing through the notch on each circular wall;
a pad with a first end and a second end, which is mounted on the outer thread part with the first end and the second end striding between two circular walls; and
a fastening element, which locks onto the outer thread part outside the pad and guides the sliding block to move within the accommodating room so that the second teeth urges tightly against the first teeth in the radial direction of the rod and the tooth surface of the second teeth is blocked by the tooth surface of the first teeth to prevent the sliding block from tilting on the rod as the fastening element rotates, thereby urging the rod to the cylindrical rotating block, wherein the axle hole goes from the cylindrical rotating block through one sidewall of the accommodating room, an opposite sidewall of the accommodating room has a recess, a connecting hole goes through the recess, the rod goes through the accommodating room and into the recess, the rod urges against the recess, a limiting member has an outer thread part and a head part, with the outer thread part going through the connecting hole and locking into the screw hole, a gap L is formed between the head part and the end surface of the rod, with the gap L being wider than the depth of the connecting hole, and the rod is secured to the cylindrical rotating block with the limiting member inserted into the screw hole, and the sliding block having a width that is larger than a distance between two circular walls, and a distance between the inlet and two notches is larger than the width of the sliding block.

2. The joint instrument support assembly of claim 1, wherein the axle hole goes through the rotating block at a uniform diameter, a stopping block also strides across the outer edges of the two circular walls with the pad, one end of the rod has a small-diameter section whose diameter is the same as the axle hole, the small-diameter section goes through the stopping block into the axle hole, the rod has a screw hole on its end surface, a limiting element with an outer thread part locks in the screw hole to restrict the rod inside the rotating block, and a gap exists between the rod and the rotating block for the rod to rotate therein.

3. The joint instrument support assembly of claim 3, wherein the length of the small-diameter section of the rod is slightly longer than the axle hole of the rotating block, the limiting element goes through a pad by its outer thread part and locks in the screw hole of the rod, and the annular diameter of the pad is greater than the axle hole.

4. The joint instrument support assembly of claim 1, wherein the rotating block has an inlet on one end of the accommodating room that is larger than the width of the sliding block and an outlet on the other end that is smaller than the width of the sliding block.
